(19) United States
(12) Patent Application Publication
(10) Pub. No.: US 2024/0296468 A1
(43) Pub. Date: Sep. 5, 2024

(54) USING ARTIFICIAL INTELLIGENCE TO STRATEGICALLY ALLOCATE RESOURCES FOR IMPROVED THROUGHPUT

(71) Applicant: Microsoft Technology Licensing, LLC, Redmond, WA (US)

(72) Inventors: Sameeksha S. SUBHEDAR, Redmond, WA (US); Michael S. SEAMONS, Satellite Beach, FL (US); Rohit GUPTA, Redmond, WA (US)

(21) Appl. No.: 18/116,125

(22) Filed: Mar. 1, 2023

(51) Int. Cl. G06F 9/50

(52) U.S. Cl. CPC G06Q 30/0202; G06Q 10/0637

(57) ABSTRACT

Described are examples for generating an allocation of resources, or designing strategies for resource allocation using artificial intelligence (AI). The allocation of resources or strategies can be generated based on an AI model trained using various aggregations of event data, where the event data identifies one or more properties related to an agent, an action performed by the agent, and an event attributable to the action.

### BACKGROUND

Effective or optimal resource allocation across agents can be an issue in multiple domains. For instance, a system or administrator can be charged with allocating resources to motivate a set of agents (e.g., human or otherwise) to achieve a goal of maximizing strategically targeted returns. Optimally allocating the resources such to channel the motivation to achieve desired results may be challenging for the system or administrator given the complexity of associated event data. Indeed, there can be challenges in ensuring that the distribution of resources results in proper motivation to achieve certain events. Some distributions may lead to wasted resources, as well as misguided or suboptimal event trajectories.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an example, a computer-implemented method for generating an allocation of resources is provided that includes obtaining event data indicating events occurring for multiple agents, wherein the event data identifies an agent, an action performed by the agent, and an event attributable to the action, aggregating, for training an artificial intelligence (AI) model, the event data in a first dimension to associate events having an event criteria that meets a threshold achieved by one or more agents, aggregating, for training the AI model, the event data from the first dimension in a second dimension based on a trajectory of events having one or more similar values for certain event criteria, aggregating, for training the AI model, the event data from the second dimension in a third dimension based on one or more actions associated with the events, training the AI model using the event data from the third dimension, and using the AI model to generate an indication for allocation of resources related to the one or more agents for performing at least a subset of the one or more actions related to the events.

In another example, a device for generating an allocation of resources is provided that includes a memory storing instructions, and at least one processor coupled to the memory. The processor is configured to execute the instructions to receive event data indicating events occurring for multiple agents, wherein the event data identifies an agent, an action performed by the agent, and an event attributable to the action, aggregate the event data in multiple dimensions, including: a first dimension to associate events having an event criteria that meets a threshold achieved by one or more agents; a second dimension based on a trajectory of events having one or more similar values for certain event criteria; and a third dimension based on one or more actions associated with the events, and generate an indication for allocation of resources based on an artificial intelligence (AI) model trained using the event data aggregated in the first dimension, the second dimension, and the third dimension.

In another example, a non-transitory computer-readable device is provided that stores instructions that, when executed by at least one computing device, cause the at least one computing device to perform operations for generating an allocation of resources, including obtaining event data indicating events occurring for multiple agents, wherein the event data identifies an agent, an action performed by the agent, and an event attributable to the action, training an artificial intelligence (AI) model using aggregated event data, including the event data aggregated in a first dimension to associate events having an event criteria that meets a threshold achieved by one or more agents, the event data from the first dimension aggregated in a second dimension based on a trajectory of events having one or more similar values for certain event criteria, and the event data from the second dimension aggregated in a third dimension based on one or more actions associated with the events, and using the AI model to generate an indication for allocation of resources related to the one or more agents for performing at least a subset of the one or more actions related to the events.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a schematic diagram of an example of a device for performing functions related to providing an indication of resource allocation for incentive-based resources, in accordance with aspects described herein.

FIG. 2 is a flow diagram of an example of a method for providing an indication of incentive-based resource allocation, in accordance with aspects described herein.

FIG. 3 illustrates a conceptual data diagram of a company organization and aggregation of data related to various agents in accordance with aspects described herein.

FIG. 4 is a schematic diagram of an example of a device for performing functions described herein, in accordance with aspects described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes various examples related to using multiple aspects of artificial intelligence (AI) along with data aggregation to provide an indication of incentive-based allocation for resources. Aggregating the data can relate to performing synthesis on data collected. For example, various factors can be considered in providing the indication of the resource allocation, such as areas of growth for focusing (e.g., based on need or strategy), probability of conversion of actions into events in those areas, prioritization of actions that achieve conversion to events, allocation of weights to the foregoing, etc. The disclosure describes certain example problem spaces in more detail, such as a sales organization obtaining an indication of monetary resource allocation to motivate sales, but the concepts described herein can be applied in substantially any problem space having certain events that result from actions performed by agents, as described herein. Other examples of such problem spaces or fields that can leverage motivation in this regard may include a banking investment domain (e.g., stock purchases), real estate domain (e.g., agent commission), an employee rewards motivation, etc.

For example, resource allocation for maximized returns can be broken down into the above factors, and an AI-based system may be used for optimizing each of the factors built on top of feedback loops and/or data aggregation. The problem of resource allocation can be expressed as a sequential multi-dimensional prioritization, which may be based on the above factors. To optimize resource allocation, each of these factors can be codified, represented, and/or optimized using various techniques described herein. In the examples described herein, resource allocation can be optimized or improved in this regard, which can allow for reduction in resources used due to optimization or improvement in allocation. In addition, in the examples described herein, insight into determining strategy for conversion of actions into desired events (e.g., sales) can be provided.

In some examples, aspects described herein can provide a structured mechanism for resource allocation for incentives for maximizing strategic returns. In some examples, systems and corresponding functionality described herein can facilitate reasoning over data by synthesizing through a multi-dimensional approach, leveraging AI insights over multiple information sources identifying sale need, current acquisition contours, propensity of sale, effectiveness of actions driving conversion, actor proclivity, as well as simulations and estimations enmeshing human insight with data-backed system optimization approaches. In some examples, systems and corresponding functionality described herein can identify or provide a framework for touchpoints between data-driven system generated optimizations and human intervention in order to develop a design strategy that is both systemically optimal as well as aligned to strategic goals, at the same time targeted towards areas of need. In some examples, systems and corresponding functionality described herein can reduce investment resources used by increasing efficiencies and optimizations, and at the same time can put in place an automata that can continue providing targeted insights and optimizations, which may be fed back into the system for improvement over time.

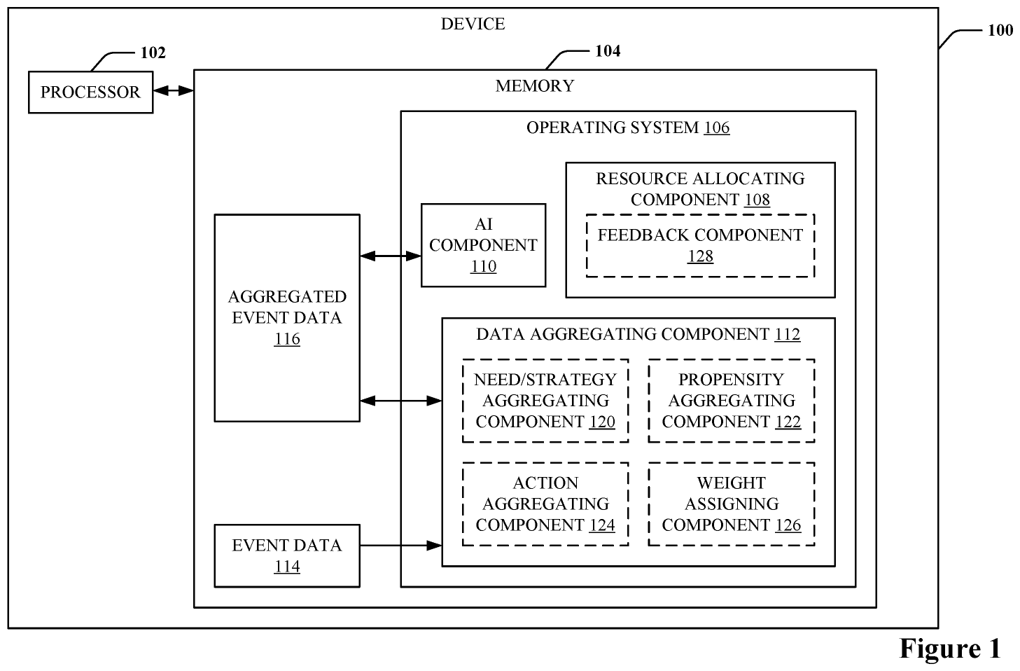

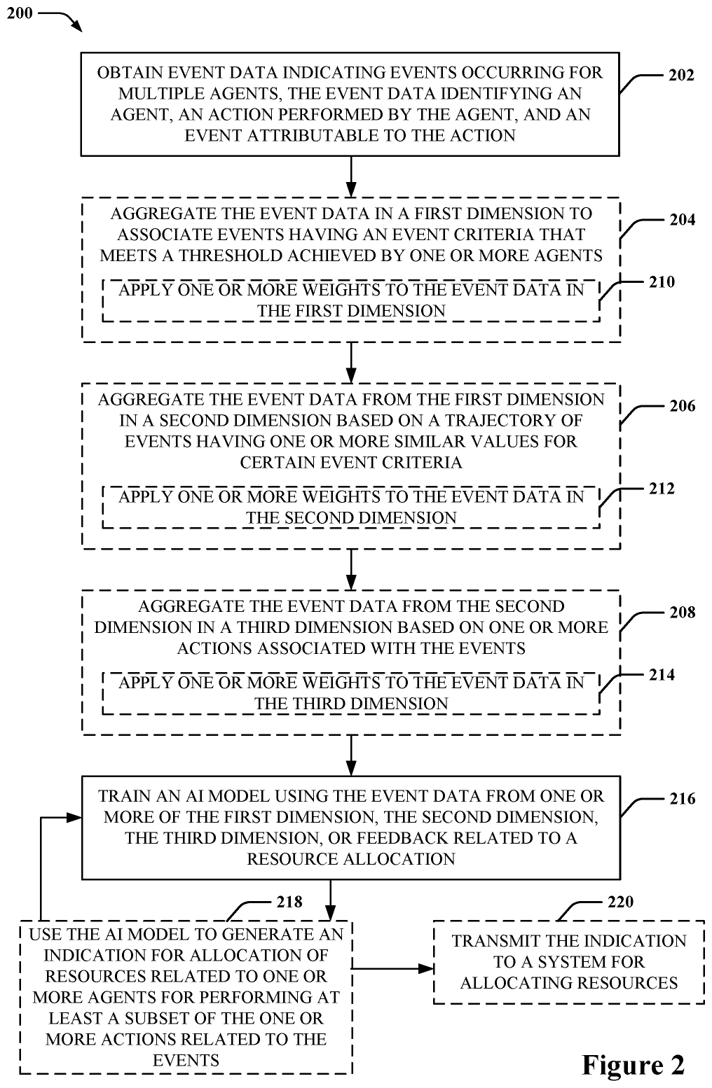

Turning now to FIGS. 1-4, examples are depicted with reference to one or more components and one or more methods that may perform the actions or operations described herein, where components and/or actions/operations in dashed line may be optional. Although the operations described below in FIG. 2 are presented in a particular order and/or as being performed by an example component, the ordering of the actions and the components performing the actions may be varied, in some examples, depending on the implementation. Moreover, in some examples, one or more of the actions, functions, and/or described components may be performed by a specially-programmed processor, a processor executing specially-programmed software or computer-readable media, or by any other combination of a hardware component and/or a software component capable of performing the described actions or functions.

FIG. 1 is a schematic diagram of an example of a device 100 (e.g., a computing device) for performing functions related to providing an indication of resource allocation for incentive-based resources. In an example, device 100 can include a processor 102 and/or memory 104 configured to execute or store instructions or other parameters related to providing an operating system 106, which can execute one or more applications or processes. For example, processor 102 and memory 104 may be separate components communicatively coupled by a bus (e.g., on a motherboard or other portion of a computing device, on an integrated circuit, such as a system on a chip (SoC), etc.), components integrated within one another (e.g., processor 102 can include the memory 104 as an on-board component), and/or the like. Memory 104 may store instructions, parameters, data structures, etc. for use/execution by processor 102 to perform functions described herein.

In one example, the operating system 106 can execute one or more applications or processes, such as, but not limited to, a resource allocating component 108 for defining or generating an allocation of resources, an AI component 110 for training an AI model associated with certain data, or a data aggregating component 112 for aggregating certain data in one or more dimensions. In addition, in an example, the memory 104 may store event data 114 related to events performed by agents of a company, and/or aggregated event data 116 that can be aggregated by data aggregating component 112. In other examples, one or more of the various components 108, 110, or 112, and/or the data 114 or 116, may be provided by, or otherwise stored on, a different device, with which device 100 can communicate (e.g., over a network). In one specific example, a first device can implement and/or execute the resource allocating component 108, which can communicate with an AI component 110 provided by a second device to generate a resource allocation based on an AI model. In another specific example, a third device can implement the data aggregating component 112, which can independently aggregate event data 114 (which may also be stored on another device) to generate aggregated event data 116, which the second device can obtain for training the AI model via AI component 110, as described further herein.

In an example, the event data 114 can include data that includes indications of at least an agent, an action performed by the agent, and an event attributable to the action. For example, the event data 114 can be stored by, retrieve from, etc. a database of event data, which may correspond to sales transactions, stock transactions, real estate transactions, employee performance events, and/or substantially any data that identifies an agent or property of an agent (e.g., a geographical location associated with the agent), a category of goods to which the action relates, a time period or associated property of the action (e.g., a time of year), an action performed by the agent, and an event attributable to the action (e.g., conversion of the action into a desirable event, such as a sale). Data aggregating component 112 can include various components for aggregating the event data 114 in one or more dimensions. In one example, data aggregating component 112 can optionally include a need/strategy aggregating component 120 for aggregating the event data 114 by associating events having a desired event criteria achieved by one or more agents, such as a positive conversion outcome for the event (e.g., a sale), or a strategic event outcome, a propensity aggregating component 122 for aggregating the event data 114 based on a trajectory of events having one or more similar values for certain event criteria, an action aggregating component 124 for aggregating the event data 114 based on one or more actions associated with the events that resulted in event conversion, and/or a weight assigning component 126 for assigning weights to the event data or the aggregated event data at one or more dimensions.

In an example, data aggregating component 112 can store aggregated event data 116 that can include the event data 114 as aggregated in one or more dimensions. AI component 110 can train an AI model based on the aggregated event data 116, and the resource allocating component 108 can use the AI model to create a resource allocation allocating resources among agents, actions, etc. to optimize or improve the resource allocation to achieve a specific goal (e.g., maximized sales). In an example, resource allocating component 108 can include a feedback component 128 for indicating feedback related to the resource allocation, and AI component 110 may also use the feedback to train the AI model to improve resulting resource allocations based on success or effectiveness of historical resource allocations.

FIG. 2 is a flowchart of an example of a method 200 for providing an indication of incentive-based resource allocation. For example, method 200 can be performed by a device 100 and/or one or more components thereof to facilitate aggregated event data on multiple levels (or in multiple dimensions) to generate the indication of incentive-based resource allocation.

In method 200, at action 202, event data indicating events occurring for multiple agents can be obtained, where the event data identifies an agent, and action performed by the agent, and an event attributable to the action. In an example, data aggregating component 112, e.g., in conjunction with processor 102, memory 104, operating system 106, etc., can obtain the event data 114 indicating events occurring for multiple agents, where the event data 114 identifies the agent, the action performed by the agent, and the event attributable to the action. For example, the event data 114 can include data from one or more systems that tracks events resulting from actions by agents, such as a sales transaction system, marketing system, or other corporate data system, and data aggregating component 112 can obtain the event data 114 from one or more such systems. For example, the event data 114 can include data indicating the events as sales transactions that resulted from actions taken by certain agents, where specific examples of actions may include implementing a social network marketing campaigns for a product, implementing an in-store marketing campaigns for a product, building of a new store or pop-up store to sell product, etc. The event data 114 can associate the events (e.g., the converted sales) with actions based on feedback received or implied at the point of purchase (e.g., based on a link clicked that resulted in the sales transaction, based on a location of the sales transaction, based on questionnaire data for the sales transaction, etc.). The event data 114 can be generated by multiple sources and may be vast, and the event data 114 can identify, or facilitate identification of, an event, an agent associated with the event, and an action performed by the agent that resulted in the event.

In method 200, optionally at action 204, the event data can be aggregated in a first dimension to associate events having an event criteria that meets a threshold achieved by one or more agents. In an example, need/strategy aggregating component 120, e.g., in conjunction with processor 102, memory 104, operating system 106, etc., can aggregate the event data in the first dimension to associate events having the event criteria that meets the threshold (e.g., a positive event conversion from an action) achieved by one or more agents. For example, need/strategy aggregating component 120 can aggregate the data having common values for the desired event criteria to provide insight as to which criteria are resulting in the desired events, or are resulting in a threshold event metric value corresponding to the desired events. For example, the desired event metric may include a number of sales (e.g., over a period of time), a total amount of sales, aggregated over stores associated with the sales, geographic regions associated with the sales, time periods associated with the sales (e.g., a time of year, such as season, quarter, month, etc.), etc. In an example, need/strategy aggregating component 120 can aggregate the desired event data for each of multiple agents or actions of the multiple agents, which can provide insight for allocating incentive-based resources to the agents and/or to the agents across regions, categories, time periods etc. for performing the specific actions leading to the desired event.

For example, the desired event can relate to or specify areas of grown to focus on (e.g., need), such as agents or regions of agents having achieved at least a threshold (or a highest) event metric, such as a region having the highest sales total for a period of time. In an example, a resource allocation may provide more resources to such a region (or otherwise allocate resources to various regions in proportion to, or otherwise based on, sales total). In another example, the desired event can be specified as a strategic goal or strategic event outcome, such as to increase sales in a particular region. In this example, a resource allocation may provide more resources to the region based on additionally or alternatively on the strategic goal. In an example, the strategic goal can be indicated to the data aggregating component 112 by resource allocating component 108, which may obtain the strategic goal from input from personnel seeking to obtain the resource allocation. For example, aggregating the event data 114 based on the desired event, whether need-based or strategy-based, can allow for generating AI insights over product purchase and product usage event data, which can be aggregated over the dimensions of categories, geographies etc. For example, need/strategy aggregating component 120 can aggregate the event data 114 in this regard to help identify the magnitude of demand, help identify footprint trends that inform strategic decisions, etc. The combination of actual needs and strategic decisions based on these insights may offer a quantified approach to determine need for resource allocation among agents or for certain geographical regions of agents, etc., which can form a basis of designing motivation.

In method 200, optionally at action 206, the event data from the first dimension can be aggregated in a second dimension based on a trajectory of events having one or more similar values for certain event criteria. In an example, propensity aggregating component 122, e.g., in conjunction with processor 102, memory 104, operating system 106, etc., can aggregate the event data from the first dimension in the second dimension based on a trajectory of events having one or more similar values for certain event criteria. For example, for each set of aggregated data aggregated by the need/strategy aggregating component 120, propensity aggregating component 122 can further aggregate the data based on the trajectory events, which may be indicative of a trend or propensity of events (e.g., a trend or propensity of consumer purchases of a product, which may relate back to one or more data related to events (e.g. customer demographic)). For example, propensity aggregating component 122 can aggregate the data detecting a trend or association over a period of time between certain event criteria values, where the trend or association may be detected within a set of data that is aggregated in the first dimension or across different sets of data that are aggregated in the first dimension.

For example, the certain event criteria may indicate associations between actions that lead to a similar or the same event, events having a first event criteria (e.g., sale of a certain product or goods or services) that lead events having second event criteria (e.g., sale of another product), events having some different and some similar criteria (e.g., sale of one product leading to sale of another product to a same customer in a certain region or consumer segment), etc. In addition, for example, propensity aggregating component 122 can aggregate data having similar event criteria (e.g., sale of a certain product) and can aggregate the data having similar other features, such as similar consumer demographic information, similar sale region, similar consumer purchase history, similar type of product, etc. In this regard, for example, propensity aggregating component 122 can aggregate data that facilitates determining a path of least resistance towards need fulfillment, how probable are customers to complete the sale across the various dimensions of goods, geography, price range, etc. For example, propensity aggregating component 122 can aggregate the data for propensity analysis based on purchase trajectories of similar customers, or upgrades co-related with other factors, such as organization scale, usage of certain features etc. This can help inform how likely a customer is to complete the purchase given a need. Various AI models can be implemented that codify these features to generate probability of purchase that can be used to generate an indication of resource allocation for motivating maximizing returns.

In method 200, optionally at action 208, the event data from the second dimension can be aggregated in a third dimension based on one or more actions associated with the events. In an example, action aggregating component 124, e.g., in conjunction with processor 102, memory 104, operating system 106, etc., can aggregate the event data from the second dimension in the third dimension based on the one or more actions associated with the events. For example, action aggregating component 124 can aggregate the event data from the second dimension (e.g., as aggregated based on trajectory or propensity) based on the event data having a similar or same action that resulted in the event. This can facilitate associating an action with certain desired events, whether the same event that achieves the desired event criteria from aggregation in the first dimension, similar events that also achieve a similar event criteria from aggregation in the second dimension, etc.

For example, once need, strategy, and/or propensity are identified, further aggregation of the data based on the action that resulted in the events can provide an indication of a desirable set of actions to take to produce similar events in the future (e.g., sale actions to take in order to convert the sale). This can correlate to the effectiveness of actions as well as proclivity of the agents who are to be motivated towards certain actions based on a variety of factors. In an example, action aggregating component 124 can aggregate the data in this regard over history of action fulfillment of the agents as well as aggregated insights over conversion effectiveness of actions. When aggregated from the data that has been aggregated in the first and second dimensions, for example, data aggregation further based on action can provide insight into actions that were taken that resulted in, or are predicted to result in, the desired events, the trajectory of events, etc. (e.g., insight into actions that generated desired sales or can generate sales given the detected trajectory). As described, for example, the actions can be certain social media marketing campaigns, pop-up store locations, etc., and thus an indication of resource allocation can be provided to recommend or provide resource allocation to certain agents for performing those actions to generate the desired events. Aggregating the event data based on action can also provide insight as to proclivity of the agents (e.g., in performing specific actions or otherwise). This can also lead to resource allocation to those agents when the aggregated data is AI modeled.

In one example, as described, the data aggregating component 112 can aggregate the event data 114 in these various dimensions to generate aggregated event data 116. For example, the aggregated event data 116, and/or raw event data (e.g., event data 114), can be used by the AI component 110 to train one or more AI models for providing an indication of incentive-based resource allocation based on the aggregated event data 116 to achieve a certain need or strategy, based on a detected propensity, based on corresponding actions to achieve the certain need or strategy and/or based on the propensity, etc. In addition, the AI component 110 can use the one or more AI models to infer the propensity based on the multiple dimensions associated with a desired event, as described above.

In another example, weights can be used in aggregating the data or otherwise training the AI model. In an example, weight assigning component 126 can assign weights to data aggregations or corresponding determined resource allocations based on various considerations. In one example, weight assigning component 126 can assign weights based on history of resource allocation to agents and/or actions associated with achieving the events and the effect of the allocation on desired outcome. In another example, weight assigning component 126 can assign weights based on simulations performed using resource allocations and corresponding predicted events or event outcomes (e.g., sales simulations based on historical data that generate sales predictions). In another example, weight assigning component 126 can assign weights based on whether or to what extent a certain factor contributes to an event having desired event criteria. For example, weight assigning component 126 can determine that propensity related to a set of events having desired event criteria (e.g., a converted sale from an action) influenced the set of events more than the associated action (e.g., the similar event criteria leading to propensity, such as demographic information, has more influence on the desired outcome than the specific actions leading to each of the set of events), weight assigning component 126 can assign more weight to the propensity data aggregation than the action aggregation. In this regard, for example, weight assigning component 126 can use the weights to express a relative importance between the factors (or data aggregations) as well as subfactors within each factor (e.g., different aspects of propensity).

In one example, weight assigning component 126 can run multiple automated simulations of weighted assignments to generate estimations on the optimal distribution of the available resources. Weight assigning component 126 can use insights from the history of resource consumption by the agents, for the proposed actions, geographies, goods, and/or other dimensions. In an example, weight assigning component 126 can create multiple distribution contours delineating relative weights at aggregated and granular dimensions for strategic review to ensure that the distribution is optimal both from a human and/or system efficiency perspective. Weight assigning component 126, for example, can generate weights based on received or inferred feedback from previous resource allocations (e.g., as received from feedback component 128 or otherwise).

For example, in aggregating the event data in the first dimension at action 204, optionally at action 210, one or more weights can be applied to the event data in the first dimension. In an example, weight assigning component 126, e.g., in conjunction with processor 102, memory 104, operating system 106, etc., can apply one or more weights to the event data in the first dimension. For example, weight assigning component 126 can assign weight to an aggregation of event data, where the weight may correspond to a measurement of an event metric of one or more events in the aggregated data (e.g., as compared to or as a proportion of other measurements of the event metric of events in other aggregations of data). For example, weight assigning component 126 can assign the weight to the aggregation of event data to indicate a resource allocation in the first dimension. In another example, weight assigning component 126 can assign the weight based on feedback received from feedback component 128 regarding efficacy of a previous allocation of resources, which may be indicated by personnel responsible for allocating the resources, an AI component 110 that determines an event metric resulting from a prior allocation of resources in the first dimension (e.g., based on previously determined or indicated need or strategy), etc.

In another example, in aggregating the event data in the first dimension at action 204, optionally at action 212, one or more weights can be applied to the event data in the second dimension. In an example, weight assigning component 126, e.g., in conjunction with processor 102, memory 104, operating system 106, etc., can apply one or more weights to the event data in the second dimension. For example, weight assigning component 126 can assign weight to an aggregation of event data, where the weight may correspond to a measurement of an event metric of one or more events in the aggregated data (e.g., as compared to or as a proportion of other measurements of the event metric of events in other aggregations of data) for data aggregations that are based on the trajectory detected for certain events having similar event criteria (e.g., actions and/or agents, etc.). For example, weight assigning component 126 can assign the weight based on the event metric or the trajectory, such as by assigning higher weights for events with a greater trajectory towards desirable events, such as higher weights for events having certain event criteria, such as higher weights for a particular demographic, or customer segment, higher weights for sales of multiple items to the same consumers or demographics, etc., as described. For example, weight assigning component 126 can assign the weight to the aggregation of event data to indicate a resource allocation in the second dimension. In another example, weight assigning component 126 can assign the weight based on feedback received from feedback component 128 regarding efficacy of a previous allocation of resources, which may be indicated by personnel responsible for allocating the resources, an AI component 110 that determines an event metric resulting from a prior allocation of resources in the second dimension (e.g., based on previous propensity determination), etc.

For example, in aggregating the event data in the first dimension at action 204, optionally at action 214, one or more weights can be applied to the event data in the third dimension. In an example, weight assigning component 126, e.g., in conjunction with processor 102, memory 104, operating system 106, etc., can apply one or more weights to the event data in the third dimension. For example, weight assigning component 126 can assign weight to an aggregation of event data, where the weight may correspond to a measurement of an event metric of one or more events in the aggregated data (e.g., as compared to or as a proportion of other measurements of the event metric of events in other aggregations of data) for data aggregations that are based on actions that result in desired events. In an example, when combined with or performed after the other weightings of aggregated data, such as for example, weighting propensity data, weight assigning component 126 can assign weights to event data that is aggregated according to a propensity (e.g., aggregated according to demographic event criteria of the event data) having a similar action that resulted in the event. This can associate the propensity and the corresponding similar action(s) (e.g., marketing efforts, store openings, etc.) that facilitate events (e.g., sales) along the associated propensity criteria (e.g., similar consumer demographic). For example, weight assigning component 126 can assign the weight to the aggregation of event data to indicate a resource allocation in the third dimension, such as assigning higher weights to data corresponding to actions that produce higher event metrics. (i.e. higher weights to certain actions etc.) In another example, weight assigning component 126 can assign the weight based on feedback received from feedback component 128 regarding efficacy of a previous allocation of resources, which may be indicated by personnel responsible for allocating the resources, an AI component 110 that determines an event metric resulting from a prior allocation of resources in the third dimension (e.g., based on previous actions resulting in certain event metrics), etc.

In method 200, at action 216, an AI model can be trained using the event data from one or more of the first dimension, the second dimension, the third dimension, or feedback related to a resource allocation. In an example, AI component 110, e.g., in conjunction with processor 102, memory 104, operating system 106, etc., can train the AI model using the event data from one or more of the first dimension, the second dimension, the third dimension, or feedback related to a resource allocation. In one example, AI component 110 can train the AI model based on data from multiple dimensions. Similarly, for example, AI component 110 can train multiple AI models based on data from multiple dimensions, such as one AI model per dimension, or other AI models based on data from one or more of the multiple dimensions, etc. In an example, as described, data aggregating component 112 can aggregate the event data 114 in multiple dimensions (e.g., the first, second, and third dimensions, and also based on assigning weights) to generate aggregated event data 116. AI component 110, in one example, can train the AI model using the aggregated event data 116.

In method 200, optionally at action 218, the AI model can be used to generate an indication for allocation of resources related to one or more agents for performing at least a subset of the one or more actions related to the events. In an example, resource allocating component 108, e.g., in conjunction with processor 102, memory 104, operating system 106, etc., can use the AI model to generate the indication for allocation of the resources related to the one or more agents performing at least a subset of the one or more actions related to the events. In an example, resource allocating component 108 can generate the indication for allocation of the incentive-based resources to the one or more agents, to a geography of, or related to, the one or more agents, to one or more categories of agents, according to a timeline of activities, for specific actions to be performed by the agents, and/or the like. For example, resource allocating component 108 can provide an input regarding a total number of resources to be allocated, and can receive, from AI component 110, an indication of agents and/or corresponding actions to which to allocate the resources. In another example, resource allocating component 108 can receive an indication of resource allocation proportion to agents and/or corresponding actions, and can determine how to allocate a total number of resources based on the proportions. In an example, resource allocating component 108 can automatically allocate the resources to the agents (e.g., through a financial institution interface), or can provide a notification of the financial incentives along with the corresponding actions to the agents. Once the agents perform the actions, resource allocating component 108 can provide the financial reward to the agents, etc. In another example, resource allocating component 108 can provide an indication of proportions or resources to personnel charged with allocating the resources, and the personnel can manually allocate the resources

In method 200, optionally at action 220, the indication can be transmitted to a system for allocating resources. In an example, resource allocating component 108, e.g., in conjunction with processor 102, memory 104, operating system 106, etc., can transmit the indication to the system for allocating resources. As described above, this can include transmitting the indication of the allocation of resources to another system that allocates the resources, another system that tracks resource allocation, a feedback system that provides information on previous resource allocations, etc. Other systems can accordingly use this information to allocate the resources among agents, actions, etc., transmit or provide the resources to the agents, actions, etc. or associated systems, and/or the like. In addition, in one example, resource allocating component 108 can format the indication of allocation of resources into a predetermined format that is normalized for providing to another system, so the other system can appropriately receive the information and/or correspondingly allocate the resources.

In an example, results corresponding to the allocation of resources at action 218 can be fed back into the AI component 110 for training the AI model at action 216 and/or to data aggregating component 112 for future aggregations of event data 114. For example, data aggregating component 112 and/or AI component 110 can determine or assign weights to certain data aggregations or other facets of the AI model based on results of the resource allocation (e.g., apply more weight to actions and/or agents that resulted in improved event metrics or event metrics that achieve a threshold level, etc.).

In an example, once resources are allocated, data can again be aggregated to determine the efficacy of allocating the resources (e.g., whether the allocation resulted in actions having the desired event conversion). Feedback can be applied to multiple scenarios to, for example, gauge effectiveness of resource allocation, gauge effectiveness of actions, and/or gauge effectiveness of actions and allocation on propensity and proclivity of agents, etc. These inputs can be fed back into the AI model or data aggregations to improve the efficacy thereof. An example is once the AI model is trained with an initial set of aggregated data based on data sets such as past purchases, action effectiveness, agent activity etc., AI component 110 can output, by using the AI model, a distribution for the resource allocation. Once this allocation is in effect, new event data can be generated (e.g., for purchases, actions and propensity). This new event data may be provided as a stream for training future AI models, to provide insights and correlations between assigned allocations and events (e.g., effect on sales), etc. This new event data may also be fed into the original system for more accurate and current view of the world to influence future allocation generations. Similar implementations may be performed for more local analysis, such as effect of resource allocations on actions taken by agents and how the weightage and allocation is actually incentivizing agents.

In an example, resource allocating component 108 can indicate the strategic goal to the data aggregating component 112 for aggregating the data in the first dimension based on previous resource allocations and resulting event data. For example, using AI insights and techniques described herein, resource allocating component 108 can determine event data from previous resource allocations showing a number of events having the desired event criteria to be less than a threshold in a particular region (or for a particular collection of agents). For example, this can be based on data aggregating component 110 aggregating previous event data for the purpose of resource allocating component 108 providing a previous allocation of incentive-based resources or otherwise. In one example, resource allocating component 108 can set a strategic goal to have more desired events (e.g., product sales) in this particular region or collection of agents in the need/strategy aggregating component 120, and need/strategy aggregating component 120 can aggregate data in the first dimension based on achieving this strategic goal for the current (or future) resource allocation (e.g., at action 204).

Aspects described herein can use AI-based structured methodology to codify motivation, AI-based structured methodology to design strategy, propensity analysis to inform motivation and strategy, aggregated AI insights over feedback loops to provide predictions to inform motivation and strategy, automated simulations to inform motivation and strategy, and/or feedback loops over motivation automata to generate continuously evolving optimizations.

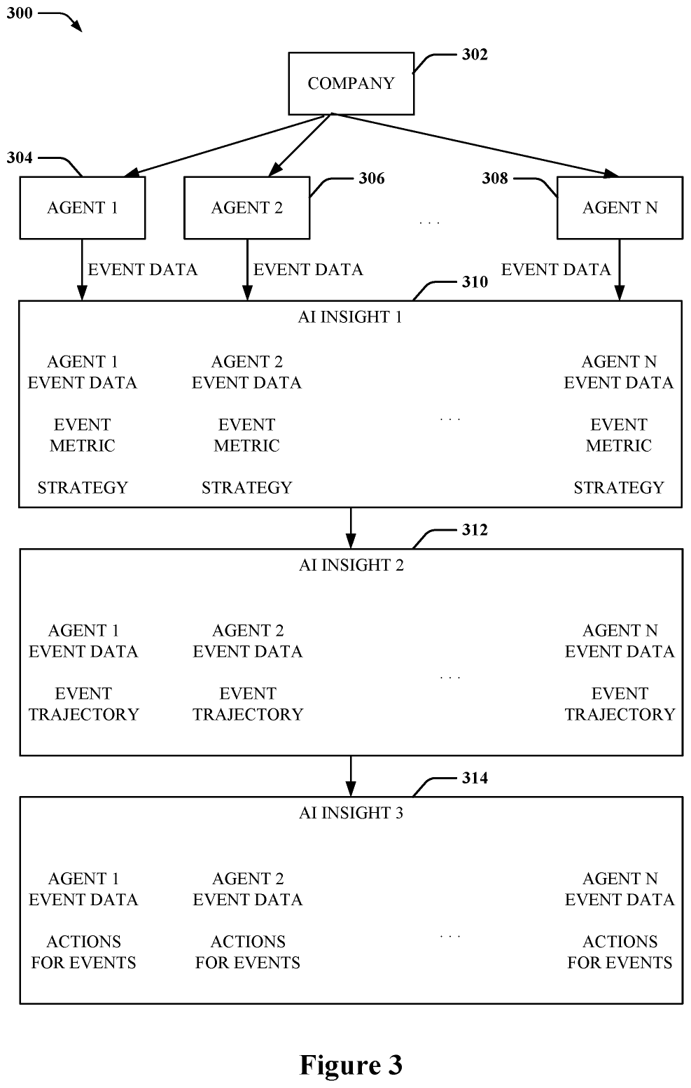

FIG. 3 illustrates a conceptual data diagram 300 of a company organization and aggregation of data related to various agents in accordance with aspects described herein. For example, a company 302 can have multiple agents, such as agent 1 304, agent 2 306, . . . , agent N 308, where N is a positive integer. The agents can be, or can be included in, certain geographies (e.g., geographical regions) having agents, categories of agents or corporate divisions, etc. There can be event data for the company 302 that is associated with each agent 304, 306, and 308, and includes data regarding events associated with actions performed by each agent 304, 306, and 308, as described. The event data can be aggregated in various dimensions to provide various AI insights that can be used in training an AI model, as described. The various AI insights can facilitate determining a resource allocation of incentive-based resources among the agents 304, 306, and 308.

For example, the event data can be aggregated for AI insight 1 310 based on an event metric and/or a strategy. For example, the event metric may indicate a resource allocation need, such as a sales total for the agent (e.g., for a particular item or otherwise), where the sales total can be proportionate to the resource need at the agent to convert actions into sales events for items. In another example, the strategy can be an inferred or specified strategy related to an agent. For example, the agent may be in a geographical region within which the company desires to increase sales, or a trend of selling similar items can be detected in the geographical region, etc. Data for AI insight 1 310 can be aggregated to improve the event metric or strategy or otherwise allocate resources in accordance with the event metric or strategy. In one example, a weight can be applied to the data aggregations that indicates a resource allocation to be assigned to each agent 304, 306, and 308. For example, in this regard, weight can be assigned based on past purchases or defined market strategy, etc.

In addition, for example, the event data can be aggregated for AI insight 2 312 based on a detected event trajectory. For example, the event trajectory can be detected by aggregating data having similar event criteria, such as consumer demographic, region, product type, etc., and detecting trends among consumer purchases having similar event criteria. In this regard, AI insight 2 312 can provide insight into first purchases or other events that lead to other purchases or events, and can provide additional resource allocation for promoting the first purchases or other events or the other purchases or events led to from the first purchases or other events. In one example, this can include providing additional resource allocation to the agents or to actions associated with causing the first purchase events, adding new agents or actions based on the propensity-related data, etc. Data for AI insight 2 312 can be provided for each agent or action and on top of (or using) the data aggregations produced by the first AI insight 1 310. In one example, a weight can be applied to the data aggregations that indicates resource allocation to be assigned to actions within data for each agent 304, 306, and 308, which can lead to a certain event trajectory, as described. For example, in this regard, AI insight 2 312 can provide for weight assignment for customer segment based on customer-specific analysis (e.g., how likely is a consumer to purchase from an agent, purchasing power of a consumer for purchasing from the agent, higher weightage for a customer demographic etc.), which can be determined based on purchase history event data and determined usage trajectory, as described.

In addition, for example, the event data can be aggregated for AI insight 3 314 based on actions causing certain events. For example, the actions for events can be determined for events in the data aggregated at an agent and based on trajectory, as aggregated from AI insight 2 312. Data for AI insight 3 314 can be aggregated based on determining which actions provide the desired events (e.g., the events that have a desired outcome or trajectory, based on need or strategy, etc.). In one example, a weight can be applied to the data aggregations that indicates resource allocation to be assigned to actions within data aggregations for each agent 304, 306, and 308 and/or that lead to a certain event trajectory, as described. For example, in this regard, AI insight 3 314 can provide for weight assignment based on Actions that are working to convert to events, based on a detected proclivity of agents to perform certain actions that lead to desirable events (e.g., events having a threshold outcome or event metric), etc.

As described in various aspects above, the weight to assign at each AI insight can be based on feedback loops. For example, each data aggregating component can determine how much weightage to apply, and/or how much total weightage to apply at each AI insight. This can be based on feedback as well. For example, data aggregating component 112 or AI component 110, as described, can determine previous resource allocations and efficacy thereof to achieve one or more desired events. In another example, AI component 110 can perform simulations based on simulated resource allocations to predict efficacy of achieving the one or more desired events (e.g., based on historical event data) and can accordingly assign weights for future resource allocations. In yet another example, data aggregating component 112 or AI component 110 can assign weights based on resource consumption. In another example, AI component 110 can perform simulations based on simulated resource allocations and output the simulation results to allow for determining a weightage to apply to the various AI insights 310, 312, or 314.

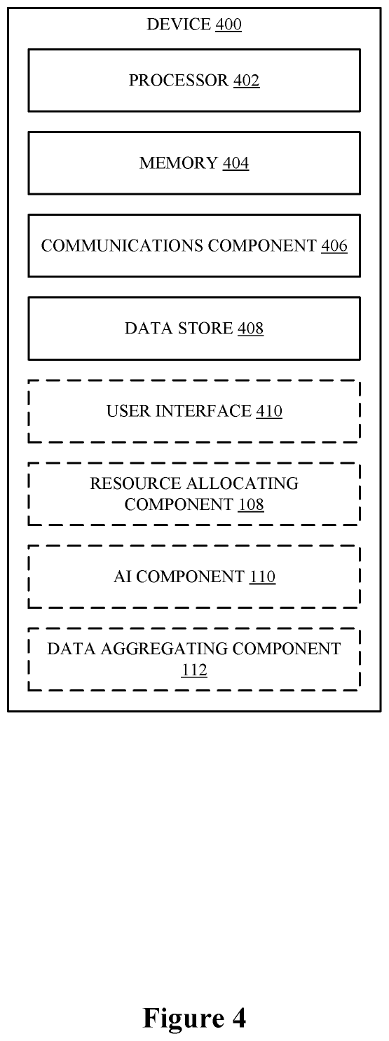

FIG. 4 illustrates an example of device 400 including additional optional component details as those shown in FIG. 1. In one aspect, device 400 may include processor 402, which may be similar to processor 102 for carrying out processing functions associated with one or more of components and functions described herein. Processor 402 can include a single or multiple set of processors or multi-core processors. Moreover, processor 402 can be implemented as an integrated processing system and/or a distributed processing system.

Device 400 may further include memory 404, which may be similar to memory 104 such as for storing local versions of operating systems (or components thereof) and/or applications being executed by processor 402, such as a resource allocating component 108, AI component 110, data aggregating component 112, etc. Memory 404 can include a type of memory usable by a computer, such as random access memory (RAM), read only memory (ROM), tapes, magnetic discs, optical discs, volatile memory, non-volatile memory, and any combination thereof.

Further, device 400 may include a communications component 406 that provides for establishing and maintaining communications with one or more other devices, parties, entities, etc. utilizing hardware, software, and services as described herein. Communications component 406 may carry communications between components on device 400, as well as between device 400 and external devices, such as devices located across a communications network and/or devices serially or locally connected to device 400. For example, communications component 406 may include one or more buses, and may further include transmit chain components and receive chain components associated with a wireless or wired transmitter and receiver, respectively, operable for interfacing with external devices.

Additionally, device 400 may include a data store 408, which can be any suitable combination of hardware and/or software, that provides for mass storage of information, databases, and programs employed in connection with aspects described herein. For example, data store 408 may be or may include a data repository for operating systems (or components thereof), applications, related parameters, etc.) not currently being executed by processor 402. In addition, data store 408 may be a data repository for resource allocating component 108, AI component 110, data aggregating component 112, and/or one or more other components of the device 400.

Device 400 may optionally include a user interface component 410 operable to receive inputs from a user of device 400 and further operable to generate outputs for presentation to the user. User interface component 410 may include one or more input devices, including but not limited to a keyboard, a number pad, a mouse, a touch-sensitive display, a navigation key, a function key, a microphone, a voice recognition component, a gesture recognition component, a depth sensor, a gaze tracking sensor, a switch/button, any other mechanism capable of receiving an input from a user, or any combination thereof. Further, user interface component 410 may include one or more output devices, including but not limited to a display, a speaker, a haptic feedback mechanism, a printer, any other mechanism capable of presenting an output to a user, or any combination thereof.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are expressly included and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A device for generating an allocation of resources, comprising:
a memory storing instructions; and
at least one processor coupled to the memory and configured to execute the instructions to:
receive event data indicating events occurring for multiple agents, wherein the event data identifies an agent, an action performed by the agent, and an event attributable to the action;
aggregate the event data in multiple dimensions, including:
a first dimension to associate events having an event criteria that meets a threshold achieved by one or more agents;
a second dimension based on a trajectory of events having one or more similar values for certain event criteria; and
a third dimension based on one or more actions associated with the events; and
generate an indication for allocation of resources based on an artificial intelligence (AI) model trained using the event data aggregated in the first dimension, the second dimension, and the third dimension.

2. The device of claim 1, wherein the event criteria corresponds to a number of events having a positive conversion from an associated action.

3. The device of claim 1, wherein the event criteria is specified as a strategic event outcome.

4. The device of claim 3, wherein the at least one processor is further configured to execute the instructions to obtain the strategic event outcome based on generating a previous indication for allocation of resources based on the event data or previous event data.

5. The device of claim 1, wherein the certain event criteria includes a same customer or consumer segment associated with the events, or a similar type of products associated with the events.

6. The device of claim 1, wherein the at least one processor is further configured to execute the instructions to assign one or more weights to the event data in at least one of the first dimension, the second dimension, or the third dimension.

7. The device of claim 6, wherein the at least one processor is further configured to execute the instructions to obtain the one or more weights based on feedback from a previous allocation of resources to the one or more agents for performing the one or more actions.

8. The device of claim 6, wherein the at least one processor is further configured to execute the instructions to determine the one or more weights based on automating one or more simulations of allocating resources to the one or more agents for performing the one or more actions based on the event data.

9. A computer-implemented method for generating an allocation of resources, comprising:
obtaining event data indicating events occurring for multiple agents, wherein the event data identifies an agent, an action performed by the agent, and an event attributable to the action;
aggregating, for training an artificial intelligence (AI) model, the event data in a first dimension to associate events having an event criteria that meets a threshold achieved by one or more agents;
aggregating, for training the AI model, the event data from the first dimension in a second dimension based on a trajectory of events having one or more similar values for certain event criteria;
aggregating, for training the AI model, the event data from the second dimension in a third dimension based on one or more actions associated with the events;
training the AI model using the event data from the third dimension; and
using the AI model to generate an indication for allocation of resources related to the one or more agents for performing at least a subset of the one or more actions related to the events.

10. The computer-implemented method of claim 9, wherein the event criteria corresponds to a number of events having a positive conversion from an associated action.

11. The computer-implemented method of claim 9, wherein the event criteria is specified as a strategic event outcome.

12. The computer-implemented method of claim 11, further comprising obtaining the strategic event outcome based on using the AI model to generate a previous indication for allocation of resources based on the event data or previous event data.

13. The computer-implemented method of claim 9, wherein the certain event criteria includes a same customer or consumer segment associated with the events, same purchase history among customers associated with the events, same sale region for customers associated with the events, or a similar type of products associated with the events.

14. The computer-implemented method of claim 9, further comprising assigning one or more weights to the event data in at least one of the first dimension, the second dimension, or the third dimension.

15. The computer-implemented method of claim 14, further comprising obtaining the one or more weights based on feedback from a previous allocation of resources to the one or more agents for performing the one or more actions.

16. The computer-implemented method of claim 14, further comprising determining the one or more weights based on automating one or more simulations of allocating resources to the one or more agents for performing the one or more actions based on the event data.

17. A non-transitory computer-readable device storing instructions thereon that, when executed by at least one computing device, cause the at least one computing device to perform operations for generating an allocation of resources, comprising:
obtaining event data indicating events occurring for multiple agents, wherein the event data identifies an agent, an action performed by the agent, and an event attributable to the action;
training an artificial intelligence (AI) model using aggregated event data, including the event data aggregated in a first dimension to associate events having an event criteria that meets a threshold achieved by one or more agents, the event data from the first dimension aggregated in a second dimension based on a trajectory of events having one or more similar values for certain event criteria, and the event data from the second dimension aggregated in a third dimension based on one or more actions associated with the events; and
using the AI model to generate an indication for allocation of resources related to the one or more agents for performing at least a subset of the one or more actions related to the events.

18. The non-transitory computer-readable device of claim 17, wherein the event criteria corresponds to a number of events having a positive conversion from an associated action.

19. The non-transitory computer-readable device of claim 17, wherein the event criteria is specified as a strategic event outcome.

20. The non-transitory computer-readable device of claim 19, wherein the instructions cause the at least one computing device to obtain the strategic event outcome based on using the AI model to generate a previous indication for allocation of resources based on the event data or previous event data.
